(19) United States
(12) Patent Application Publication
(10) Pub. No.: US 2026/0279005 A1
(43) Pub. Date: Sep. 17, 2026

(54) BLOODSTAIN PATTERN CLASSIFICATION DEVICE AND METHOD USING BLOODSTAIN PATTERN CLASSIFICATION ALGORITHM BASED ON BLOODSTAIN PATTERN CLASSIFICATION SYSTEM FEATURES

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Young Il SEO, Wonju-si (KR); Ho Yong YIE, Wonju-si (KR)

(21) Appl. No.: 19/223,413

(22) Filed: May 30, 2025

(30) Foreign Application Priority Data
Mar. 11, 2025 (KR) 10-2025-0031502

(51) Int. Cl. G06V 10/764; G06V 10/94; G06V 20/50

(52) U.S. Cl. CPC G06V 10/764; G06V 10/945; G06V 20/50

(57) ABSTRACT

A bloodstain pattern classification method using a bloodstain pattern classification algorithm based on bloodstain pattern classification system features includes obtaining a bloodstain image, performing first classification to fourth classification of the bloodstain image according to bloodstain pattern features, and outputting a classification result.

### CROSS-REFERENCE TO RELATED APPLICATIONS

The present application is based on and claims priority to Korean Patent Application No. 10-2025-0031502, filed on Mar. 11, 2025, in the Korean Intellectual Property Office, which is incorporated herein by reference in its entirety.

### BACKGROUND

### 1. Field

One or more embodiments relate to a bloodstain pattern classification device and method using a bloodstain pattern classification algorithm based on bloodstain pattern classification system features.

### 2. Description of the Related Art

A bloodstain is a stain formed when blood falls, splashes, or spreads on a surface or object. Bloodstains are not simple stains, but appear in various forms depending on the way blood flowed and environmental factors at the time.

In criminal cases, bloodstain pattern analysis (BPA) plays an important role in reconstructing the scene of a bloody incident and understanding the crime scene.

The bloodstain pattern analysis is conducted according to the methodology of distinguishing and observing bloodstain patterns, classifying bloodstain patterns, and identifying, estimating, and reconstructing behavior based on bloodstains. Using this bloodstain pattern analysis technique to determine human behavior requires a lot of experience and specialized knowledge.

Among the bloodstain pattern analysis operations, bloodstain pattern classification is one of the most important operations, and in the field of bloodstain pattern analysis, classifying and distinguishing various bloodstain patterns is a key task.

### SUMMARY

One or more embodiments include a bloodstain pattern classification device and method using a bloodstain pattern classification algorithm that easily performs classification when observing bloodstain patterns at a crime scene based on bloodstain pattern classification system features.

According to one or more embodiments, a bloodstain pattern classification method using a bloodstain pattern classification algorithm based on bloodstain pattern classification system features includes: obtaining a bloodstain image; performing first classification, which classifies the bloodstain image into a spatter stain and a non-spatter stain according to bloodstain pattern features; performing second classification, which classifies the spatter stain into a linear spatter and a non-linear spatter according to whether bloodstains are distributed linearly, and classifies the non-spatter stain into an irregular margin and a regular margin according to whether the margins are regular; performing third classification, which classifies the linear spatter into a spurt, swing cast-off pattern, drip trail, and cessation cast-off pattern (linear), classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains, classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and classifies the regular margin into a pattern transfer, saturation stain, flow pattern, pool, and irregular pattern transfer; performing fourth classification, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern; and outputting a classification result.

In an embodiment, the outputting of the classification result may include displaying results of the first classification to the fourth classification on a display, respectively.

In an embodiment, the outputting of the classification result may include highlighting nodes corresponding to the results of the first classification to the fourth classification on a logic tree using a graphical user interface (GUI).

According to one or more embodiments, a bloodstain pattern classification device using a bloodstain pattern classification algorithm based on bloodstain pattern classification system features includes: at least one memory storing at least one instruction; and at least one processor, wherein the at least one processor is configured to execute the at least one instruction to: obtain a bloodstain image; perform first classification, which classifies the bloodstain image into a spatter stain and a non-spatter stain according to bloodstain pattern features; perform second classification, which classifies the spatter stain into a linear spatter and a non-linear spatter according to whether bloodstains are distributed linearly, and classifies the non-spatter stain into an irregular margin and a regular margin according to whether the margins are regular; perform third classification, which classifies the linear spatter into a spurt, swing cast-off pattern, drip trail, and cessation cast-off pattern (linear), classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains, classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and classifies the regular margin into a pattern transfer, saturation stain, flow pattern, pool, and irregular pattern transfer; perform fourth classification, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern; and output a classification result.

In an embodiment, the at least one processor is configured to execute the at least one instruction to output the classification result, including displaying results of the first classification to the fourth classification on a display, respectively.

In an embodiment, the at least one processor is configured to execute the at least one instruction to output the classification result, including highlighting nodes corresponding to the results of the first classification to the fourth classification on a logic tree using a GUI.

A non-transitory computer-readable recording medium having recorded thereon a computer program according to an embodiment may execute a bloodstain pattern classification method using a bloodstain pattern classification algorithm based on bloodstain pattern classification system features using a computer.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic configuration diagram of a bloodstain pattern classification device according to an embodiment;

FIG. 2 is a view of a bloodstain pattern classification system according to bloodstain pattern;

FIG. 3 is a flowchart illustrating a bloodstain pattern classification method according to an embodiment;

FIG. 4 is an exemplary view of spatter stains;

FIG. 5 is an exemplary view of non-spatter stains;

FIG. 6 is an exemplary view of linear spatters;

FIG. 7 is an exemplary view of non-linear spatters;

FIG. 8 is an exemplary view of irregular margins;

FIG. 9 is an exemplary view of regular margins; and

FIGS. 10 and 11 are views illustrating an output of a display according to an embodiment.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various elements, these elements should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

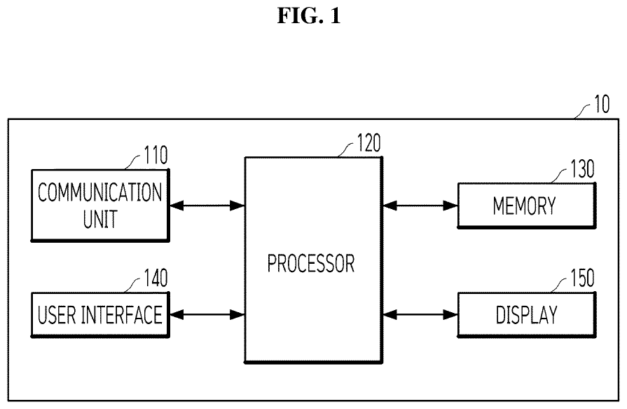

FIG. 1 is a schematic configuration diagram of a bloodstain pattern classification device according to an embodiment.

Referring to FIG. 1, a bloodstain pattern classification device 10 may include a communication unit 110, a processor 120, a memory 130, a user interface 140, and a display 150. The bloodstain pattern classification device 10 to which the disclosure is applied may be an information processing device used by a user. However, the disclosure is not limited thereto, and the bloodstain pattern classification device 10 may further include other components or some components may be omitted.

The bloodstain pattern classification device 10 may include at least one of a personal computer (PC), a laptop computer, a mobile phone, a tablet PC, a smart phone, a personal digital assistant (PDA), and a portable multimedia player (PMP).

The communication unit 110 is connected to the processor 120 and the memory 130 to transmit and receive data. The communication unit 110 may be connected to another external device to transmit and receive data. Hereinafter, the expression “transmitting and receiving A” may indicate transmitting and receiving “information or data representing A.”

The communication unit 110 may be implemented as circuitry within the bloodstain pattern classification device 10. For example, the communication unit 110 may include an internal bus and an external bus. As another example, the communication unit 110 may be an element that connects the bloodstain pattern classification device 10 to an external device. The communication unit 110 may be an interface. The communication unit 110 may receive data from an external device and transmit the data to the processor 120 and the memory 130. For example, the communication unit 110 may receive a bloodstain image from a photographing device.

The processor 120 may control operations of the bloodstain pattern classification device 10 according to an embodiment and perform logical operations.

The processor 120 processes data received by the communication unit 110 and data stored in the memory 130. The processor 120 may be a data processing device implemented in hardware having a circuit with a physical structure for performing desired operations. For example, desired operations may include code or instructions included in a program.

The processor 120 executes computer-readable code (e.g., software) stored in a memory (e.g., the memory 130) and instructions triggered by the processor 120.

The processor 120 controls the execution of a desired operation by executing at least one instruction stored in the memory 130. The at least one instruction may be stored in an internal memory included in the processor 120 or in the memory 130 included in a data processing device separately from the processor 120.

For example, the processor 120 may perform the following operations 210 to 260, which will be described in detail later.

The memory 130 stores data received by the communication unit 110 and data processed by the processor 120. The memory 130 may store a program (or application or software) that operates the bloodstain pattern classification device 10. The stored program may be coded to control the bloodstain pattern classification device 10 and may be executable by the processor 120.

The memory 130 may include a volatile memory such as static RAM (SRAM), dynamic RAM (DRAM) or synchronous DRAM (SDRAM), or a non-volatile memory such as a flash memory, phase-change RAM (PRAM), magnetic RAM (MRAM), resistive RAM (RRAM) or ferroelectric RAM (FRAM).

The user interface 140 may receive a user input for controlling the bloodstain pattern classification device 10. The user interface 140 may include, but is not limited to, a touch panel for detecting a user's touch, a button for receiving a user's push operation, a mouse or keyboard for specifying or selecting a point on a user interface screen, etc.

The user interface 140 may be, for example, at least one graphical user interface (GUI) provided for controlling the bloodstain pattern classification device 10.

The display 150 may display and output information processed in the bloodstain pattern classification device 10. For example, the display 150 may display a GUI for controlling the bloodstain pattern classification device 10.

The display 150 may be implemented as, but is not limited to, a liquid crystal display (LCD), a plasma display panel (PDP), an organic light emitting display (OLED), a field emission display (FED), an LED, a flexible display, a three-dimensional (3D) display, etc. Furthermore, the display 150 may be configured as a touch screen and used as an input device in addition to an output device.

In addition, in other embodiments, the bloodstain pattern classification device 10 may include more components than the components of FIG. 1. For example, the bloodstain pattern classification device 10 may further include other components such as a battery and charging device that powers internal components, a database, etc.

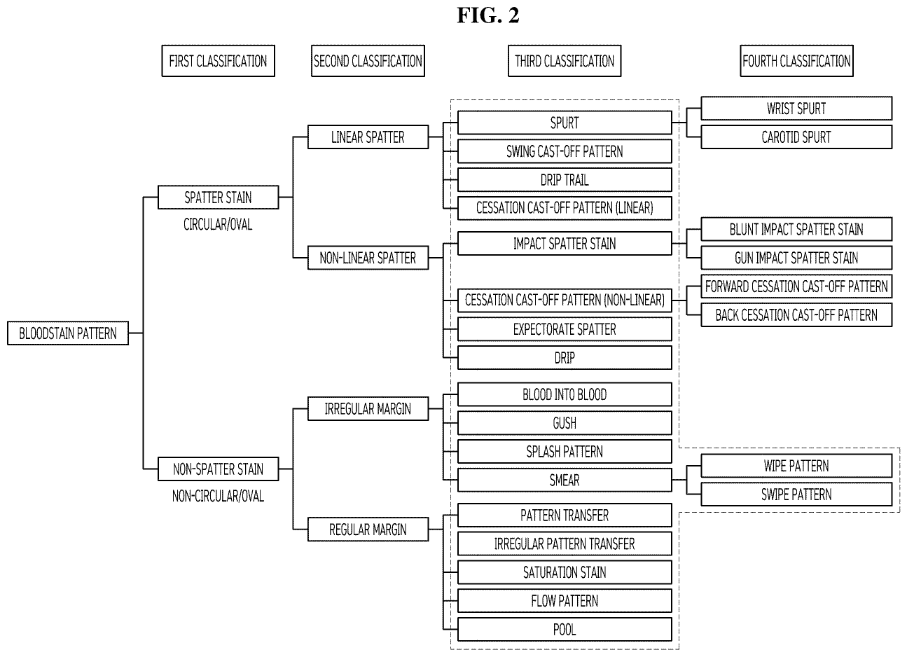

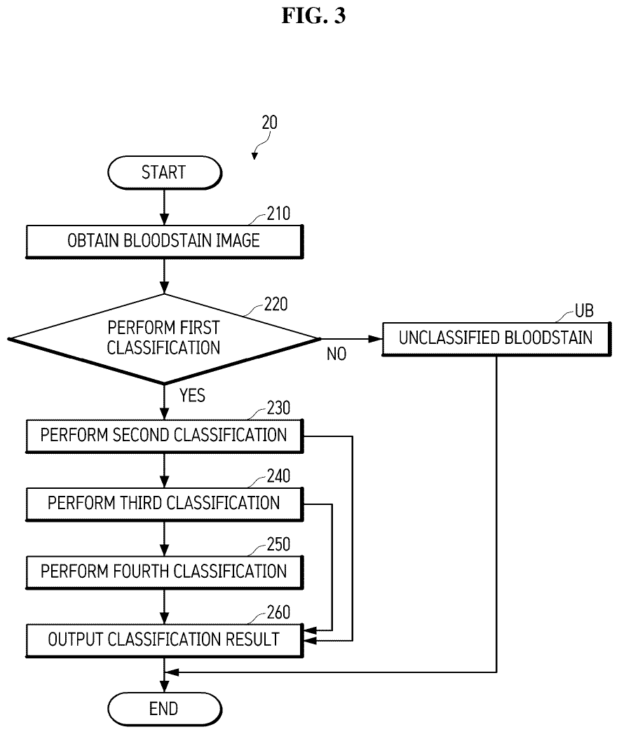

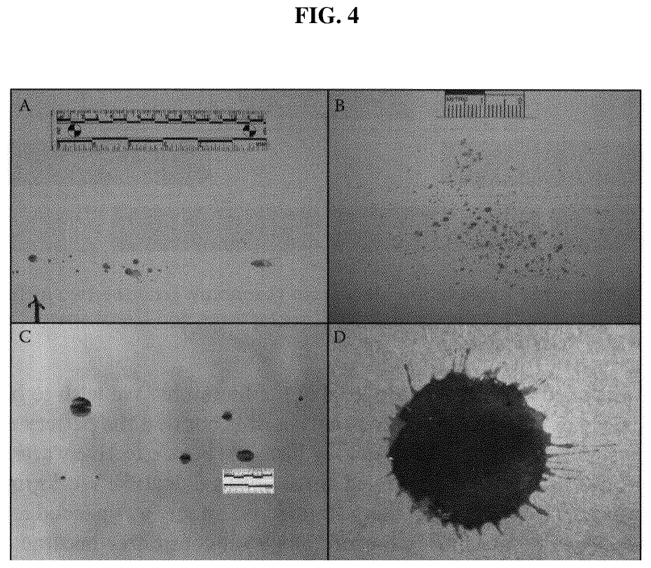

FIG. 2 is a view of bloodstain pattern classification system according to bloodstain pattern. FIG. 3 is a flowchart illustrating a bloodstain pattern classification method according to an embodiment. FIGS. 4 to 9 are views illustrating classified bloodstain patterns.

Referring to FIGS. 2 to 9, a bloodstain pattern classification method 20 according to an embodiment will be described.

The following operations 210 to 260 may be performed by the bloodstain pattern classification device 10. In addition, referring to FIGS. 2 and 3, the following operations may be performed by applying a bloodstain pattern classification algorithm using bloodstain pattern classification system features.

In operation 210, the bloodstain pattern classification device 10 may obtain a bloodstain image.

The bloodstain pattern classification device 10 may receive a bloodstain image obtained from a photographing device through the communication unit 110. In addition, the bloodstain pattern classification device 10 may include a camera including a lens and an image sensor. The image sensor may convert an image input by the lens into an electrical signal, and may be a semiconductor device such as a charge-coupled device (CCD) or a complementary metal oxide semiconductor (CMOS).

In operation 220, the bloodstain pattern classification device 10 may perform first classification, which classifies the bloodstain image into a spatter stain and a non-spatter stain according to bloodstain pattern features.

Bloodstain classification may begin by comparing physical characteristics of a distinct stain or pattern to established criteria.

Bloodstains may be classified into spatter stains and non-spatter stains.

Referring to FIG. 4, the spatter stain is a bloodstain created by free-flying blood. The spatter stain is a clear parent stain with circular or oval edges.

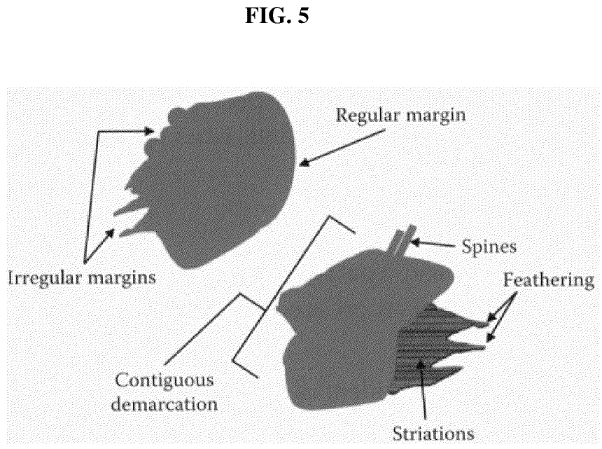

Referring to FIG. 5, the non-spatter stain is a bloodstain pattern that is different from those defined in a spatter stain group. The non-spatter stain is a primary stain that do not have a distinct oval or circular pattern.

In this case, a bloodstain that is not included in the classification category of bloodstains is an unclassified bloodstain UB.

In operation 230, the bloodstain pattern classification device 10 may perform the following second classification.

The second classification is subclassification of the first classification.

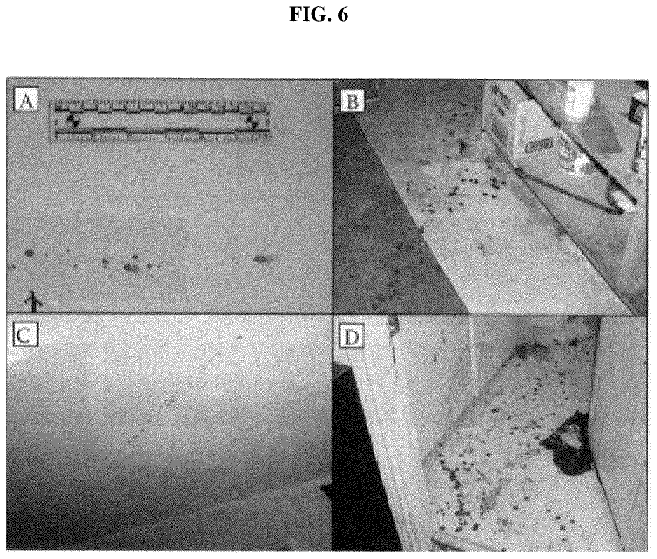

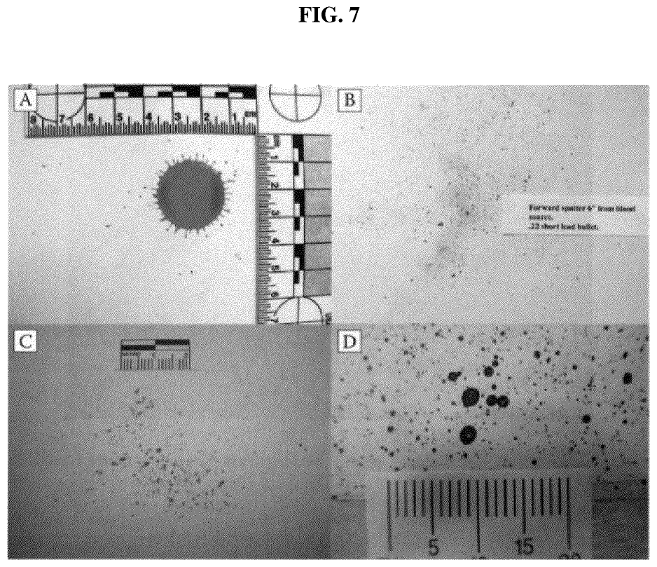

Referring to FIGS. 6 and 7, the spatter stain may be classified into a linear spatter and a non-linear spatter according to whether bloodstains are distributed linearly.

Linear spatters are related bloodstains that are distributed in a linear pattern on a target and appear continuously. The linear spatters are linearly arranged and have distinct correlations in pattern, angle of impact, and directional angle.

Non-linear spatters are a series of related scattered bloodstains that are distributed along a surface without showing a linear orientation. The non-linear spatters form non-linear patterns and are related in pattern, an angle of impact, and directional angle.

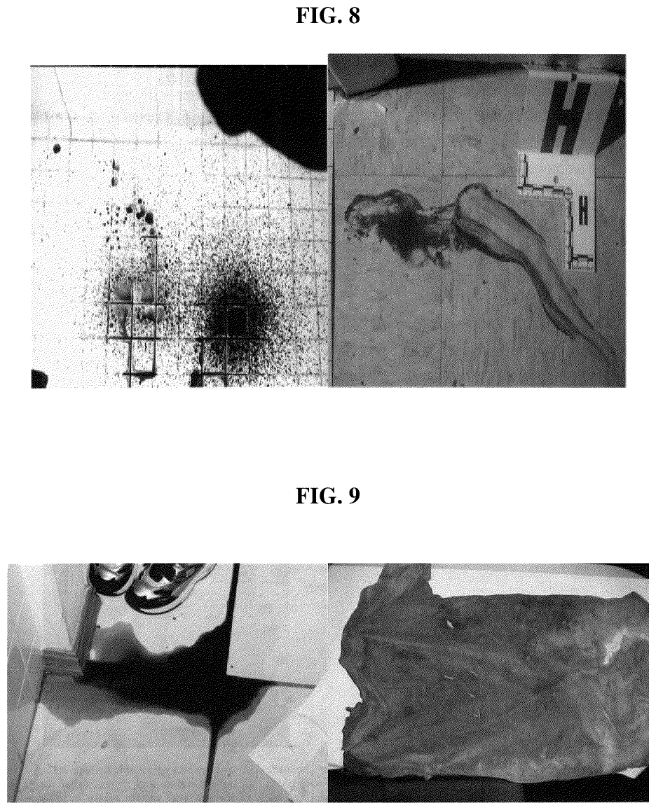

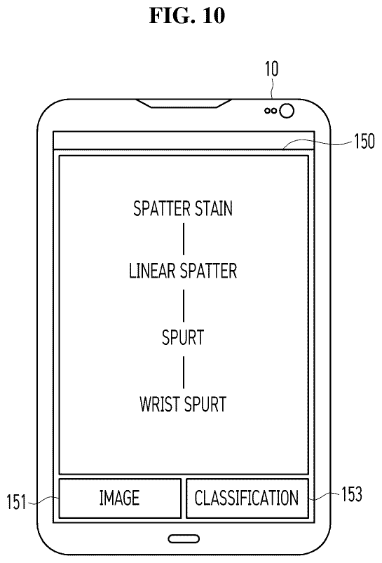

Referring to FIGS. 8 and 9, a non-spatter stain may be classified into an irregular margin and a regular margin according to whether or not the margins are regular.

The irregular margin is a bloodstain with irregular edges or spines.

The regular margin is a bloodstain with smooth or even margins that are distinguishable.

In operation 240, the bloodstain pattern classification device 10 may perform the following third classification.

The third classification is subclassification of the second classification.

### Linear Spatter

The linear spatter may be classified into a spurt, swing cast-off pattern, drip trail, and cessation cast-off pattern (linear).

The linear spatter may be classified into a spurt and a non-spurt (an irregular projected bloodstain or non-linear projected bloodstain) by determining whether individual bloodstains have a large volume. The non-spurt may be classified into a swing cast-off pattern and a drip trail based on a gradual change in angle of pattern. In addition, the linear spatter may include a previously unrecognized cessation cast-off pattern (linear).

The spurt is a bloodstain that is created when blood is spurted out under pressure, most often when an artery or the heart ruptures. In the spurts, a large amount of blood is observed in a single bloodstain. That is, the bloodstain is generally dripping down or the amount of blood is large. The spurt is a large oval bloodstain, or a linear or overlapping bloodstain, shaped like an arc or a snake. The spurt is distinguished by when blood is spurted in a large volume and when blood is spurted due to pressure.

The swing cast-off pattern is a bloodstain created by blood being detached from an object in motion. The swing cast-off pattern is straight or curved, and have a constant direction and a constant change in an angle of impact.

The drip trail is a pattern of individual spatter stain that falls on a surface and move from one point to another. The drip trail maintains a consistent size despite changes in floor conditions or reductions in blood volume. In addition, the drip trail is connected from one point to another and usually has a diameter of 3 to 25 mm.

The cessation cast-off pattern is a bloodstain that is created when blood is separated from an object that has suddenly stopped moving. The cessation cast-off pattern is a parent stain of varying size, but generally has a consistent size throughout its entire form. The cessation cast-off pattern (linear) is formed when blood flows steadily in a specific direction, following a fixed path.

### Non-Linear Spatter

Non-linear spatters may be classified into non-drips if they are radially distributed, and drips if they are not radially distributed.

A non-drip may be classified into an expectorate spatter if it has small rings or bubbles, and a non-expectorate spatter if it does not.

The expectorate spatter is a bloodstain that is spurted under pressure from the mouth, nose, or respiratory tract. Expectorate spatters may vary in size among individual spatter stains and may appear diluted in color. The expectorate spatter may include bubble outlines, mucus strings, epithelial cells, or components within the respiratory tract (e.g., amylase).

The non-expectorate spatter may be classified into an impact spatter stain if it contains circular and oval bloodstains, and an impact spatter stain or a cessation cast-off pattern (non-linear) if it contains either circular or oval bloodstains.

The impact spatter stain has a radial shape of small blood droplets created when a blood source is broken by an external force. The shape of individual bloodstains in the impact spatter stain gradually changes as they move away from the center.

The cessation cast-off pattern (non-linear) may appear when blood flows irregularly or asymmetrically in the cessation cast-off pattern described above. The cessation cast-off pattern (non-linear) was not previously recognized as a subcategory of the non-linear spatter.

A drip is a spatter stain that falls from a person or from an object with blood on it. The drip contains one or more spatter stains. A parent stain of the drip is usually large (typical diameter 3 mm to 25 mm) and may be randomly distributed on a target.

### Irregular Margin

The irregular margin may be classified into a non-smear if there are numerous spatter stains or spines, and a smear if there are none.

The non-smear may be classified into blood into blood if there are randomly oriented spatter stains at or near the margin of the stain, or a gush if there are none. In addition, the non-smear may include a splash pattern.

The blood into blood is a bloodstain in which blood falls and accumulates on top of other bloodstains or liquids, with ricochet stains attached randomly around it.

The gush is an irregular bloodstain created when a large amount of blood is spurted out.

The splash pattern is a bloodstain created by a large amount of blood falling or spilling onto a surface.

The smear is a bloodstain created when blood is transferred from one object to another through contact, moving laterally during the transfer. The smear may form feathered edges as the edges connect.

If there is a pre-existing bloodstain in the smear, it can be classified into a wipe pattern, and if not, it can be classified into a swipe pattern.

The wipe pattern is a bloodstain created by moving an object relative to a bloodstain that already exists on a surface.

The swipe pattern is a bloodstain created by the transfer of blood from an object with blood on it to another object. The swipe pattern is a form that has horizontal movement.

### Regular Margin

The regular margin may be classified into a pattern transfer, saturation stain, flow pattern, pool, and irregular pattern transfer.

The regular margin may be classified into a pattern transfer if there is a pattern in the bloodstain, and a non-pattern transfer if there is no pattern. The non-pattern transfer be may be classified into a saturation stain if it is saturated by a surface, and a non-saturation stain if it is not saturated. The non-saturation stain may be classified into a flow pattern if there is a connection along a surface perimeter, and a pool if there is no connection. In addition, the regular margin may include previously unrecognized an irregular pattern transfer.

The pattern transfer is a bloodstain that has recognizable features or patterns, created by an object carrying blood.

The saturation stain is an accumulation of liquid blood formed by blood saturated on an absorbent surface.

The flow pattern is a bloodstain formed as liquid blood moves under the influence of gravity.

The pool is a bloodstain that has accumulated due to gravity, and is a bloodstain that shows features of an area where the bloodstain has accumulated.

The irregular pattern transfer is a bloodstain that is formed when blood transfers irregularly from one object to another.

In operation 250, the bloodstain pattern classification device 10 may perform the following fourth classification.

The fourth classification is subclassification of the third classification.

The spurt may be classified into a wrist spurt and a carotid spurt depending on the location of occurrence.

The impact spatter stain may be classified into a blunt impact spatter stain and a gun impact spatter stain depending on the cause.

In addition, the cessation cast-off pattern (non-linear) may be classified into a forward cessation cast-off pattern and a back cessation cast-off pattern.

On the other hand, the unclassified bloodstain UB includes capillary action stains, blood clots, perimeter stains, voids, fly spots, ricochet stains (secondary spatters), and altered stains.

In operation 260, the bloodstain pattern classification device 10 may output a classification result.

Operation 260 of outputting the classification result may include displaying results of the first classification to the fourth classification, respectively.

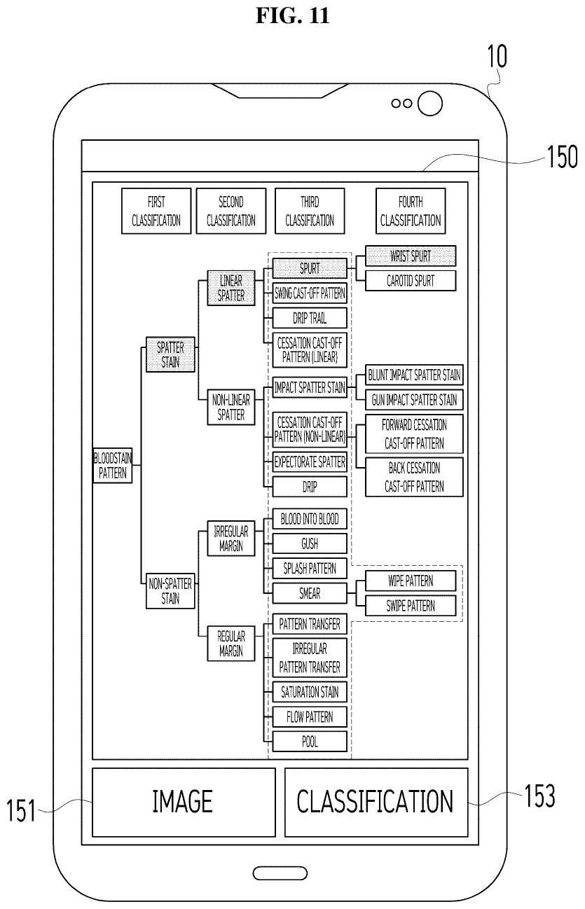

FIGS. 10 and 11 are views illustrating an output of a display according to an embodiment.

For example, referring to FIG. 10, a classification result for a specific bloodstain image may be displayed on the display 150 as follows.

The results of the first classification to the fourth classification may be displayed in order as ‘spatter stain-linear spatter-spurt-wrist spurt’.

As another example, referring to FIG. 11, operation 260 may include highlighting nodes corresponding to the results of the first classification to the fourth classification on a logic tree using a GUI.

Highlighting a node corresponding to specific classification result on the logic tree may be expressed by changing the color of the node or changing the configuration of the node (node shape, font size, etc.). In addition, highlighting can be done by expanding/reducing the size of the node.

For example, when a user selects a bloodstain image through an ‘image’ button 151 and classifies the bloodstain image through a ‘classification’ button 153, the results of the first classification to the fourth classification may be output by highlighting the node as described above. Accordingly, it is possible to check where each classification result is located on the logic tree.

The bloodstain pattern classification method 20 according to various embodiments illustrated in FIG. 3 can be written as computer programs and can be implemented in general-use digital computers that execute the programs using a non-transitory computer-readable recording medium. The non-transitory computer-readable recording medium may be a magnetic storage medium (e.g., read-only memory (ROM), a floppy disk, a hard disk, etc.), or an optical reading medium (e.g., a CD-ROM, a digital versatile disk (DVD) or the like).

According to an embodiment, bloodstain pattern classification may be easily performed when observing bloodstain patterns at a crime scene, thereby contributing to reducing fatigue of experts, increasing analysis speed, and improving accuracy when analyzing a crime scene.

The description herein is for describing the disclosure and numerous modifications and adaptations will be readily apparent to one of ordinary skill in the art without departing from the spirit and scope of the disclosure. For example, the relevant results may be achieved even when the described technologies are performed in a different order than the described methods, and/or even when the described elements such as systems, structures, devices, and circuits are coupled or combined in a different form than the described methods or are replaced or substituted by other elements or equivalents.

Accordingly, while the disclosure has been particularly shown and described with reference to embodiments thereof, it will be understood that various changes in form and details may be made therein without departing from the spirit and scope of the following claims.

What is claimed is:

1. A bloodstain pattern classification method using a bloodstain pattern classification algorithm based on bloodstain pattern classification system features, the bloodstain pattern classification method comprising:
obtaining a bloodstain image;
performing first classification, which classifies the bloodstain image into a spatter stain and a non-spatter stain according to bloodstain pattern features;
performing second classification, which classifies the spatter stain into a linear spatter and a non-linear spatter according to whether bloodstains are distributed linearly, and classifies the non-spatter stain into an irregular margin and a regular margin according to whether the margins are regular;
performing third classification, which classifies the linear spatter into a spurt, swing cast-off pattern, drip trail, and cessation cast-off pattern (linear),
classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains,
classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and
classifies the regular margin into a pattern transfer, saturation stain, flow pattern, pool, and irregular pattern transfer;
performing fourth classification, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern; and
outputting a classification result.

2. The bloodstain pattern classification method of claim 1, wherein the outputting of the classification result comprises:
displaying results of the first classification to the fourth classification on a display, respectively.

3. The bloodstain pattern classification method of claim 1, wherein the outputting of the classification result comprises:
highlighting nodes corresponding to the results of the first classification to the fourth classification on a logic tree using a graphical user interface (GUI).

4. A bloodstain pattern classification device using a bloodstain pattern classification algorithm based on bloodstain pattern classification system features, the bloodstain pattern classification device comprising:
at least one memory storing at least one instruction; and
at least one processor, wherein the at least one processor is configured to execute the at least one instruction to:
obtain a bloodstain image;
perform first classification, which classifies the bloodstain image into a spatter stain and a non-spatter stain according to bloodstain pattern features;
perform second classification, which classifies the spatter stain into a linear spatter and a non-linear spatter according to whether bloodstains are distributed linearly, and classifies the non-spatter stain into an irregular margin and a regular margin according to whether the margins are regular;
perform third classification, which classifies the linear spatter into a spurt, swing cast-off pattern, drip trail, and cessation cast-off pattern (linear),
classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains,
classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and
classifies the regular margin into a pattern transfer, saturation stain, flow pattern, pool, and irregular pattern transfer;
perform fourth classification, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern; and
output a classification result.

5. The bloodstain pattern classification device of claim 4, wherein the at least one processor is configured to execute the at least one instruction to:
output the classification result, including displaying results of the first classification to the fourth classification on a display, respectively.

6. The bloodstain pattern classification device of claim 4, wherein the at least one processor is configured to execute the at least one instruction to:
output the classification result, including highlighting nodes corresponding to the results of the first classification to the fourth classification on a logic tree using a graphical user interface (GUI).

7. A computer program stored on a non-transitory computer-readable storage medium for executing the method of claim 1 using a computer.
